(19) United States
(12) Patent Application Publication
(10) Pub. No.: US 2021/0096147 A1
(43) Pub. Date: Apr. 1, 2021

(54) REAGENT DISPENSING DEVICES

(71) Applicant: HEWLETT-PACKARD DEVELOPMENT COMPANY, L.P., Spring, TX (US)

(72) Inventors: Christie Dudenhoefer, Corvallis, OR (US); Jeffrey A. Nielsen, Corvallis, OR (US); Diane R. Hammerstad, Corvallis, OR (US); Heather B. Louderback, Corvallis, OR (US)

(73) Assignee: HEWLETT-PACKARD DEVELOPMENT COMPANY, L.P., Spring, TX (US)

(21) Appl. No.: 16/603,141

(22) PCT Filed: Jul. 18, 2017
(86) PCT No.: PCT/US2017/042614

§ 371 Date: Oct. 4, 2019

(51) Int. Cl. G01N 35/10; B01L 3/02; G01N 35/00

(52) U.S. Cl. CPC G01N 35/1002; B01L 3/0268; G01N 35/1065; G01N 35/00029; G01N 2035/00811; B01L 2200/028; B01L 2200/04; G01N 2035/00039; G01N 2035/00138; G01N 35/00732

(57) ABSTRACT

A reagent module may include a first reagent dispensing device to dispense a first range of volumes of a first reagent, and a second reagent dispensing device to dispense a second range of volumes of a second reagent where the second range of volumes is more voluminous relative to the first range of volumes. The reagent dispensing system may further include a third reagent dispensing device to dispense a third range of volumes of a third reagent where the third range of volumes is more voluminous relative to the second range of volumes.

### BACKGROUND

The life sciences research and associated diagnostic industries use a number of reagents and patient samples to perform testing and diagnostics. Dispensing liquids such as these reagents and patient samples in quantities from picoliters to microliters may be used in many areas of pharmaceutical and biology research. For example, dispensing a number of reagents in these quantities may be useful in medical and veterinary diagnostics, forensics testing, and agricultural testing to determine the presence of a chemical or biological in a sample. Even within these fields, low-volume liquid dispensing may be used for many different operations.

### BRIEF DESCRIPTION OF THE DRAWINGS

The accompanying drawings illustrate various examples of the principles described herein and are part of the specification. The illustrated examples are given merely for illustration, and do not limit the scope of the claims.

FIG. 1 is a block diagram of a reagent dispensing system, according to an example of the principles described herein.

FIG. 2 is a block diagram of a reagent module, according to an example of the principles described herein.

FIG. 3 is a block diagram of a computer program product for dispensing a reagent, according to an example of the principles described herein,

FIG. 4 is a block diagram of a reagent dispensing system, according to another example of the principles described herein.

FIG. 5 is a block diagram of a reagent module, according to an example of the principles described herein.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

Human interaction during life science research and diagnostic processes may lead to mistakes in those processes. Such mistakes may decrease the likelihood of scientific breakthroughs and increase the likelihood of misdiagnosis of patients illnesses. Further, with human interaction, these processes may prove tedious thereby increasing the costs associated with these processes as well as increase the time spent completing the processes. Automation of these processes; however, limits mistakes; time, and costs.

Instruments and tools used in life science research and diagnostic processes have been developed to increase efficiency, decrease costs, and decrease time spent conducting this research or completing diagnosis. However, even with these developments, increased numbers of reagents used to interact with a sample increase the complexity and time of completing those tasks.

In an automated, computer-driven diagnostics system, reagents may be dispensed based on a number of test protocols, and a wide variety and volumes of different reagents may be dispensed based on these test protocols. Some primary reagents may be used more regularly and consumed by a diagnostic device in relatively higher quantities than other reagents. Further, a number of less-used reagents may be used at relatively less volumes and less frequently or intermittently within fluid diagnostics.

The use of varying volumes of reagents at different frequencies within fluid diagnostics may lead to a situation where some reagents may expire or become less effective before all the reagent within that volume is consumed or dispensed. For example, less-frequently used reagents may be stored in a digitally addressable fluid ejection device, but this less-frequently used reagent may expire before all the less-frequently used reagent is consumed or dispensed resulting in an undesirable waste of that particular reagent.

Conversely, a relatively more frequently used reagent may have a consumption or dispensing rate so high that a digitally addressable fluid ejection device may be replaced relatively more often, making it difficult to provide a diagnostic testing system with enough of that highly-used reagent, and leading to waste with regard to the replacement of the digitally addressable fluid ejection device.

Further, a modular reagent dispensing system may be useful in providing wide applicability to in vitro diagnostic manufacturers and other life science companies if included within end products or manufacturing lines. A reagent dispensing system that permits for a modular change between different types and volumes of reagent dispensing devices and provides different dispense operating environments may be configured for specific customers and may be configured from day to day during use depending on the customers' applications, workflows, and testing protocols. In one example, the reagent dispensing system may enable a range of fluid dispensing devices that vary with respect to desired delivered volumes and usage rates including from very infrequently-used, low-volume fluid dispensing devices to heavily-used fluid dispensing devices with bulk reagent supplies.

Examples described herein provide a reagent dispensing system. The reagent dispensing system includes at least one station located in-line with respect to a dispersion surface, and a reagent module located at the at least one station. The reagent module may include a first reagent dispensing device to dispense a first range of volumes of a first reagent, and a second reagent dispensing device to dispense a second range of volumes of a second reagent where the second range of volumes is more voluminous relative to the first range of volumes. The reagent dispensing system may further include a third reagent dispensing device to dispense a third range of volumes of a third reagent where the third range of volumes is more voluminous relative to the second range of volumes. In one example, the third reagent dispensing device is fluidically coupled to an off-line bulk supply of reagent.

The reagent module may include a number of mechanical interfaces to align the reagent module with respect to the reagent dispensing system. Further, the reagent module may include a number of electrical interconnects to electrically interface the reagent module to the reagent dispensing system. The reagent dispensing system may send dispensing signals through the electrical interconnects to the reagent dispensing devices. Further, the reagent module may include a number of mechanical interfaces to align the reagent dispensing devices with respect to the reagent module. An identification may be located on each of the reagent modules to identify a number of reagents within each of the reagent dispensing devices.

In one example, the first reagent dispensing device may include a cassette. The cassette may include a number of first dispensing die to dispense the first range of volumes of a reagent. Further, the second reagent dispensing device may include a digitally addressable fluid ejection device. The digitally addressable fluid ejection device may include a number of second dispensing die to dispense the second range of volumes of the second reagent.

The reagent dispensing system may also include at least one environmentally-controlled area within the reagent dispensing system to preserve a number of reagents within the reagent modules. Further, the at least one station included in the reagent dispensing system may include a plurality of stations located along a reagent dispersion area. Each of the number of stations may include a number of mechanical interfaces to align the reagent modules with respect to the reagent dispensing system at each station and a number of electrical interconnects to electrically interface the reagent modules to the reagent dispensing system. Additionally, each of the stations may include environmental control that is active when specific reagent modules are located at an in-line position. The reagent dispensing system sends dispensing signals through the electrical interconnects to the reagent dispensing devices at each station.

Examples described herein provide a reagent module. The reagent module may include a plurality of reagent dispensing devices and a module frame coupling the reagent dispensing devices to a reagent dispensing system. The module frame may include a number of electrical interconnects to electrically interface the reagent dispensing devices to the reagent dispensing system. The reagent dispensing system sends dispensing signals through the electrical interconnects to the reagent dispensing devices. The reagent dispensing devices include a first reagent dispensing device to dispense a first range of volumes of a reagent, a second reagent dispensing device to dispense a second range of volumes of the reagent where the second range of volumes is more voluminous relative to the first range of volumes, and a third reagent dispensing device to dispense a third range of volumes of the reagent where the third range of volumes is more voluminous relative to the second range of volumes.

The reagent dispensing devices include a number of mechanical interfaces to align the reagent dispensing device with respect to the reagent dispensing system. In one example, the first reagent module is a cassette, the second reagent module includes a fluid ejection device comprising a number of nozzles through which the second reagent is jetted, and the third reagent module comprises a bulk fluid dispensing device.

Examples described herein provide a computer program product for dispensing a reagent. The computer program product may include a non-transitory computer readable medium comprising computer usable program code embodied therewith. The computer usable program code, when executed by a processor may identify a plurality of reagent modules. The reagent modules may include a first reagent module to dispense a first range of volumes of a first reagent, a second reagent module to dispense a second range of volumes of a second reagent where the second range of volumes is more voluminous relative to the first range of volumes, and a third reagent module to dispense a third range of volumes of a third reagent where the third range of volumes is more voluminous relative to the second range of volumes. The computer usable program code, when executed by a processor may dispense the first, second, and third reagents based on a number of test protocols. Identifying a plurality of reagent modules may include, with an identification module, identifying first, second, and third reagents within each of the reagent modules based on an identification associated with the reagent modules.

The computer program product may include computer usable program code to, when executed by the processor, exchange the reagent modules based on a type of the test protocol conducted. In one example, exchanging the reagent modules comprises instructing a reagent module transport system to exchange one of the first, second, and third reagent modules positioned at a reagent dispensing area for another of the first, second, and third reagent modules.

As used in the present specification and in the appended claims, the term “a number of” or similar language is meant to be understood broadly as any positive number comprising 1 to infinity; zero not being a number, but the absence of a number.

In the following description, for purposes of explanation, numerous specific details are set forth in order to provide a thorough understanding of the present systems and methods. It will be apparent, however, to one skilled in the art that the present apparatus, systems, and methods may be practiced without these specific details. Reference in the specification to “an example” or similar language means that a particular feature, structure, or characteristic described in connection with that example is included as described, but may or may not be included in other examples.

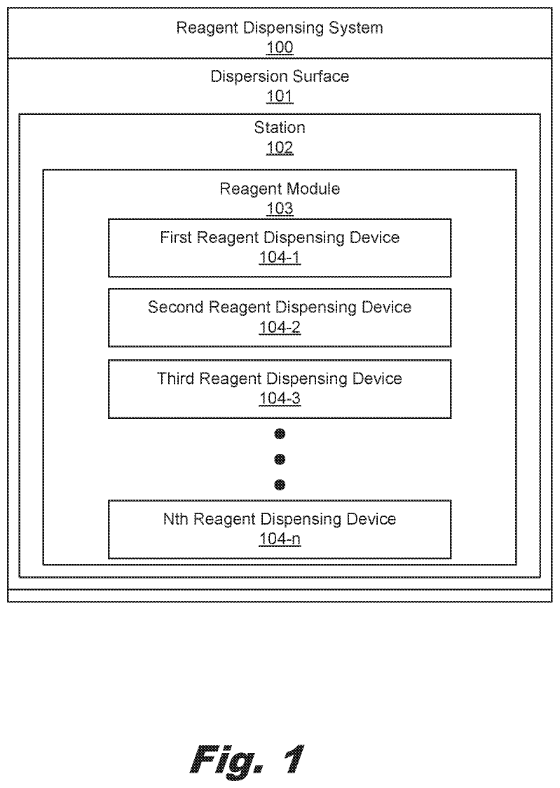

Turning now to the figures, FIG. 1 is a block diagram of a reagent dispensing system (100), according to an example of the principles described herein. The reagent dispensing system (100) may be any system that dispenses a reagent onto a substrate. In one example, the reagent dispensing system (100) is an automated, computer driven system that dispenses, through a number of reagent dispensing devices, a number of different reagents. The reagents may be any chemical or biological substance that may be used in any chemical reaction such as titrations, combinations, decompositions, single displacements, precipitations, neutralizations, double displacements, combustions, and reductions/oxidations, among other types of chemical or biological reactions. The reagents may be, for example, solutions including nucleic acid; deoxyribonucleic acid (DNA); ribonucleic acid (RNA); small (or short) interfering RNA (siRNA); polymerase chain reaction (FOR) master mix; proteins including, for example, enzymes and antibodies; other biomolecules including, for example, peptides, oligos, and lipids; small molecules, nanoparticles, biocides, cells or other tissue components; histology stains, linker reagents, inhibitors, aqueous solutions, or many other reagents.

The reagent dispensing system (100) may include a dispersion surface (101) onto which the reagents are dispensed. In one example, the reagents may be dispensed on a number of substrates that are present on the dispersion surface (101). In this example, the dispersion surface (101) may be a conveyor system on which a number of substrates are conveyed underneath a reagent module (103) located at a station (102) of the reagent dispensing system (100). In one example, the substrates may be microscope slides, test samples; cell-culture dishes such as Petri dishes, paper, tissue samples, porous media, lateral flow strip media, coated media, microtiter plates, or other substrates. In one example, there may be multiple dispersion surfaces onto which the reagents are dispensed, increasing the number of reagent modules (103) that can sequentially dispense for a given protocol.

The reagent dispensing system (100) may include any number of stations (102) at which a reagent module (103) and/or its reagent dispensing devices (104) may be presented at an in-line position relative to the dispersion surface (101). At this position at the stations (102), the reagent dispensing devices (104) of the reagent module (103) may dispense their respective reagents onto the substrates presented on the dispersion surface (101) to the reagent module (103).

In one example, the reagent module (103) may be exchanged for another reagent module (103). In this example, a number of reagent modules (103) may be located off-line with respect to the stations (102) and the dispersion surface (101), and may contain reagents within their respective reagent dispensing devices (104) that differ from those in the reagent modules (103) located at the stations (102). In one example, the reagent modules (103) positioned at the stations (102) may be exchanged by hand by, for example, a technician overseeing the processes performed by the reagent dispensing system (100). In another example, the reagent modules (103) positioned at the stations (102) may be exchanged using an automated system that utilizes tracks, robotic devices, carousels, conveyor systems, other transport systems, or combinations thereof to exchange an in-line reagent module (103) with an off-line reagent module (103).

The reagent module (103) may include a module frame to mechanically and electrically couple the reagent dispensing devices (104) within the reagent module (103) to the reagent dispensing system (100). The module frame may include a number of mechanical interfaces to align the reagent dispensing devices (104) with respect to the reagent module (103). Further, the module frame may include a number of electrical interfaces to electrically couple the reagent dispensing devices (104) to the reagent module (103), and, in turn, the reagent dispensing system (100). Signals may be sent by the reagent dispensing system (100) to the reagent dispensing devices (104) via the number of electrical interfaces of the reagent module (103). These signals may be used to instruct the reagent dispensing devices (104) to disperse a volume of reagent onto a substrate located on the dispersion surface (101). The module frame is described in more detail herein.

Each of the reagent dispensing devices (104) may be any device that dispenses a number of reagents. In one example, the reagent dispensing devices (104) may include devices that dispense different volumes of reagents. For example, a first reagent dispensing device (104-1) may dispense a first range of volumes of a reagent, a second reagent dispensing device (104-2) to dispense a second range of volumes of a reagent where the second range of volumes may be more voluminous relative to the first range of volumes, and a third reagent dispensing device (104-3) to dispense a third range of volumes of a third reagent where the third range of volumes may be more voluminous relative to the second range of volumes.

As depicted using the ellipses in FIG. 1 and the inclusion of an Nth reagent dispensing device (104-n), any number of reagent dispensing devices may be included within a reagent module (103). Each of these reagent dispensing devices (104-1, 104-2, 104-3, 104-n, collectively referred to herein as 104) may have differing architectures or form factors that allow them to dispense their respective volumes. For example, the first reagent dispensing device (104-1) may include a cassette device that dispenses between approximately 1 picoliter (pL) and 10 microliters (μL) as the first range of volumes of a reagent. The cassette may include, for example, a T8+ or D4+ dispensehead cassette produced and distributed by HP, Inc. With these types of cassettes, a relatively small amount of reagent may be dispensed at a given time. In one example, the first reagent dispensing device (104-1) or cassette may be any digitally addressable fluid ejection device that contains a very small amount of reagent on the order of approximately up to 1 milliliter (mL). Further, the fluid within the first reagent dispensing device (104-1) may come pre-filled in the first reagent dispensing device (104-1), or a technician may fill the first reagent dispensing device (104-1) with a pipette or similar preliminary, manual reagent dispensing device at the time of use of the first reagent dispensing device (104-1). The first reagent dispensing device (104-1) or cassette may be used to dispense volumes of fluid that are less frequently dispensed relative to other reagents, are negatively susceptible to environmental conditions, are expensive to inventory, are mixed immediately before use, have a relatively short shelf life, have other properties that lend their use to relatively smaller volumes, or combinations thereof.

Further, in one example, the second reagent dispensing device (104-2) may include a digitally addressable fluid ejection device. In this example, the digitally addressable fluid ejection device may include a number of fluid ejection die to dispense the second range of volumes of a reagent. For example, the second reagent dispensing device (104-2) may include a digitally addressable fluid ejection device that dispenses between approximately 100 nanoliters (nL) and 100 μL as the second range of volumes of a reagent. In one example, the digitally addressable fluid ejection device may be a thermal or piezoelectric fluid ejection device where the reagents are dispensed from an array of fluid ejection chambers and nozzles of the fluid ejection die using thermal expansion or piezoelectric forces applied to the reagents. In this example, the second reagent dispensing device (104-2) may contain, for example, 1 to 40 mL of reagent and may be pre-packaged with the reagent before the time of use. By way of frequency of use and volumes of reagent dispensed by the second reagent dispensing device (104-2), these volumes may be between approximately 1 mL to 40 mL per month.

Still further, in one example, the third reagent dispensing device (104-3) may include any high-volume reagent dispensing device such as, for example, a digitally addressable fluid ejection device fluidically coupled to an off-line bulk supply of reagent. In this example, the third reagent dispensing device (104-3) may be used in connection with the dispensing of bulk amounts of reagents. The third reagent dispensing device (104-3) may include a digitally addressable fluid ejection device that dispenses between approximately 100 nanoliters (nL) and 100 μL as the third range of volumes of a reagent. In this example, the third reagent dispensing device (104-3) may contain bulk volumes of reagent since this bulk reagent dispensing device may be used most often, Thus, third reagent dispensing device (104-3) may contain for example, 40 to 1,000 mL of reagent and may be pre-packaged with the reagent before the time of use. By way of frequency of use and volumes of reagent dispensed by the third reagent dispensing device (104-3), these volumes may be between approximately 40 mL to 1,000 mL per month.

With regard to the reagent dispensing devices (104-1, 104-2, 104-3, 104-n), a frequency of use and amount of dispersion of respective reagents within a given time period may be taken into consideration in determining what reagents are placed in what type of architecture of reagent dispensing devices (104-1, 104-2, 104-3, 104-n). For example, for reagents that are utilized relatively more often and/or at higher dispensed volumes, the third reagent dispensing device (104-3) may be used. In this example, the third reagent dispensing device (104-3) may contain reagents used daily, with dispense volumes ranging from approximately 100 nL and 100 μL. In one example, the third reagent dispensing device (104-3) may be fluidically coupled to the off-line bulk supply of reagent to allow for larger volumes of its reagent to be made available to the third reagent dispensing device (104-3).

Further, for reagents that are utilized relatively less often and/or at lower dispensed volumes relative to the third reagent dispensing device (104-3), the second reagent dispensing device (104-2) may be used. In this example, the second reagent dispensing device (104-2) may contain reagents used regularly with dispense volumes met by a fill volume of the second reagent dispensing device (104-2). The second reagent dispensing device (104-2) may be utilized for reagents used weekly to daily, with dispense volumes ranging from approximately 0.5 mL to 20 mL per month.

Still further, for reagents that are utilized relatively less often and/or at lower dispensed volumes relative to the second and third reagent dispensing device (104-2, 104-3), the first reagent dispensing device (104-1) may be used. In this example, the first reagent dispensing device (104-1) may contain reagents used intermittently or rarely with low dispense volumes of the reagent. The first reagent dispensing device (104-1) may be utilized less often than weekly, and for dispense volumes ranging from approximately 10 pL to 1 mL per month.

In this manner, the types of architectures had by the reagent dispensing devices (104-1, 104-2, 104-3, 104-n) may be individually utilized based on their dispensing volumes, their capacities, and their frequency of use. A reagent dispensing system (100) that permits for multiple architectural types of reagent dispensing devices (104-1, 104-2, 104-3, 104-n) provides for efficient management and use of reagents that vary widely in terms of their dispensing environmental conditions and their usage rate. Further, the dispensing of reagents in the manner provided by the reagent dispensing devices (104-1, 104-2, 104-3, 104-n) provides a more effective level of control as to amounts of reagents dispensed, and is easier to use relative to, for example, pipette-based methods of reagent dispensing. Further, the reagent dispensing devices (104-1, 104-2, 104-3, 104-n) allow for a more precise placement of reagents on a substrate, including onto specific regions of a tissue sample, for example. Still further, reagents dispensed by the reagent dispensing devices (104-1, 104-2, 104-3, 104-n) may be used with significantly improved efficiency since less reagents are wasted during dispensing. In one example, this increased in efficiency may be as high as 1,000 time more efficient. Even still further, the reagent dispensing devices (104-1, 104-2, 104-3, 104-n) easily combine reagents on the substrate in a digitally addressed manner such that, for example, multiple reagents may be dispensed next to one another or at the same location, as desired.

In one example, each reagent module (103) may include a single reagent dispensing device (104-1, 104-2, 104-3, 104-n), and, in this example, a number of reagent modules (103) may be exchanged with one another to an in-line position relative to the dispersion surface (101), or exist in a number of stations (102) in-line with the dispersion surface (101). The reagent modules (103), in this example, may dispense with their respective single reagent dispensing devices (104-1, 104-2, 104-3, 104-n), their respective volumes. Provisioning of a single reagent dispensing device (104-1, 104-2, 104-3, 104-n) within a reagent module (103) assists in ensuring that the reagents within the reagent dispensing devices (104-1, 104-2, 104-3, 104-n) are not cross-contaminated or cause an unexpected reaction off-line if they were grouped as a plurality of reagent dispensing devices (104-1, 104-2, 104-3, 104-n) within a reagent module (103). In another example, a plurality of the reagent dispensing devices (104-1, 104-2, 104-3, 104-n) may be grouped in a reagent module (103) based on the reagents contained in the reagent dispensing devices (104-1, 104-2, 104-3, 104-n) not having an affinity to react with one another or cross-contaminate one another.

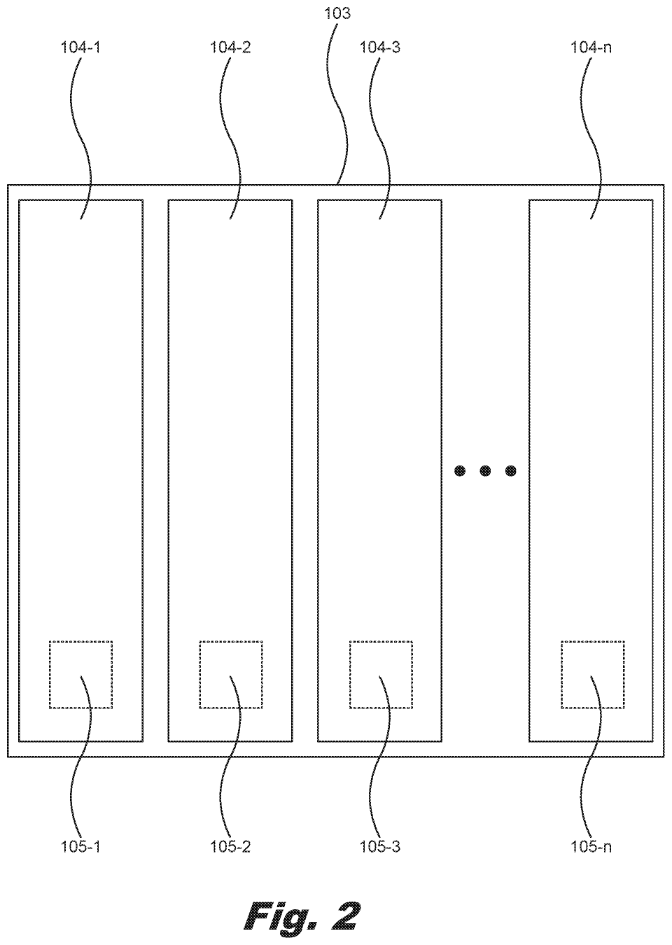

FIG. 2 is a block diagram of a reagent module (103), according to an example of the principles described herein. The reagent module (103) may include any number of reagent dispensing devices (104-1, 104-2, 104-3, 104-n).

In one example, four reagent dispensing devices (104-1, 104-2, 104-3, 104-n) may be included in the reagent module (103) as depicted in FIG. 2. However, as depicted using the ellipses in FIG. 2 and the inclusion of an Nth reagent dispensing device (104-n), any number of reagent dispensing devices may be included within a reagent module (103). Each of the reagent dispensing devices (104-1, 104-2, 104-3, 104-n) may include a volume of reagent (105-1, 105-2, 105-3, 105-n, collectively referred to herein as 105). In one example, the reagents (105-1, 105-2, 105-3, 105-n) within each of the reagent dispensing devices (104-1, 104-2, 104-3, 104-n) may be different. However, in other examples, at least two of the reagent dispensing devices (104-1, 104-2, 104-3, 104-n) among the plurality of reagent dispensing devices (104-1, 104-2, 104-3, 104-n) within the reagent module (103) may dispense an identical or substantially similar reagent.

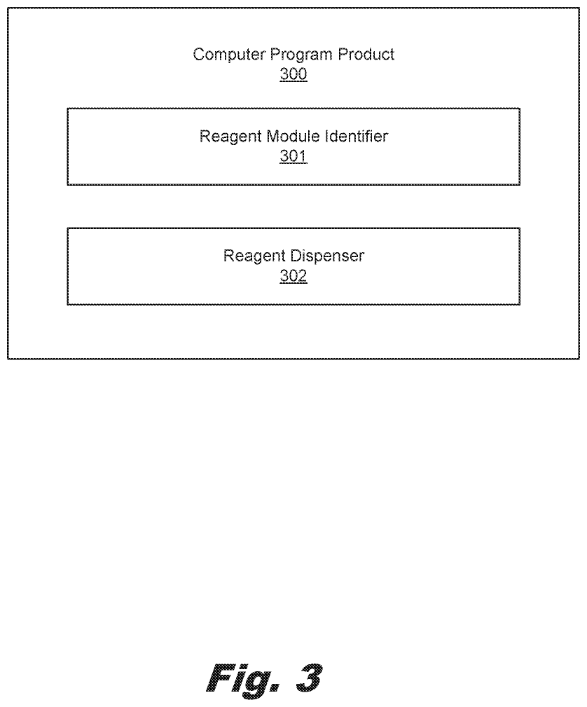

FIG. 3 is a block diagram of a computer program product (300) for dispensing a reagent, according to an example of the principles described herein. The computer program product (300) may include a non-transitory computer readable medium. The computer readable medium may include computer usable program code embodied therewith to, when executed by a processor, identify, with a reagent module identifier (301), a plurality of reagent modules (103). As described herein, the reagent modules (103) may include at least a first reagent module (103) to dispense a first range of volumes of a first reagent (105-1), and a second reagent module (103) to dispense a second range of volumes of a second reagent (105-2). The second range of volumes is more voluminous relative to the first range of volumes. The reagent modules (103) may also include a third reagent module (103) to dispense a third range of volumes of a third reagent (105-3). The third range of volumes is more voluminous relative to the second range of volumes. Each of the first, second, and third reagent modules (103) may include a number of reagent dispensing devices (104), each of which may dispense a reagent (105).

The computer readable medium may include computer usable program code embodied therewith to, when executed by a processor, dispense the first, second, and third reagents based on a number of test protocols using, for example, a reagent dispenser (302). The test protocols may be defined by a number of parameters of the tests and diagnostics to be performed by the reagent dispensing system (100) and as desired by the technicians utilizing the reagent dispensing system (100) to perform the tests and diagnostics.

In one example, the computer program product (300) may include computer usable program code embodied therewith to, when executed by a processor and with an identification module, identify the first (105-1), second (105-2), and third (105-3) reagents within each of the reagent modules (103) based on an identification associated with the reagent modules (103). In this example, the reagent modules (103) may include identification tags that identify the reagents (105-1, 105-2, 105-3, 105-n) within each of the number of reagent dispensing devices (104) included in the reagent modules (103). An electronic device that can read the identification tags may be included within the reagent dispensing system (100) to provide the identification of the reagents (105-1, 105-2, 105-3, 105-n) within each of the number of reagent dispensing devices (104) included in the reagent modules (103).

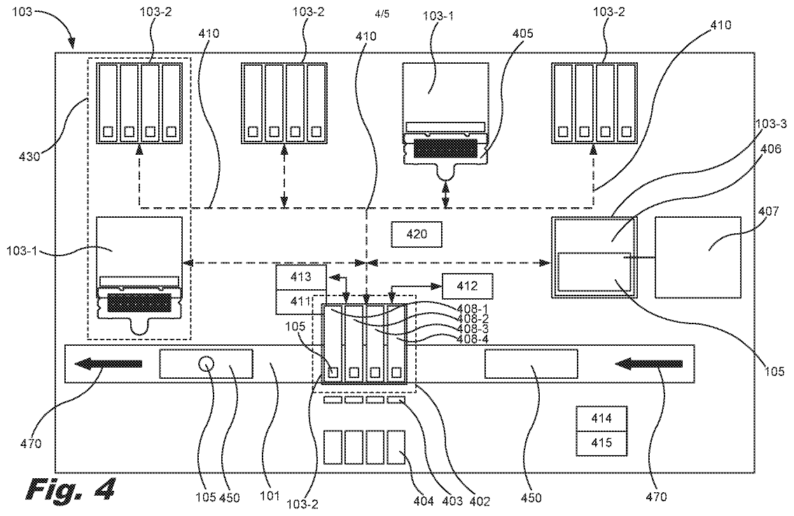

The computer program product (300) may also include computer usable program code to, when executed by the processor, exchange the reagent modules (103) based on a type of the test protocol conducted. In one example, the exchanging of the reagent modules (103) may include instructing a reagent module transport system to exchange one of the first, second, and third reagent modules (103) positioned at a reagent dispensing area for another of the first, second, and third reagent modules. More regarding this exchange of reagent modules (103) is described herein in connection with FIG. 4.

FIG. 4 is a block diagram of a reagent dispensing system (400), according to another example of the principles described herein. The reagent dispensing system (400) may include a substrate conveyance system (401) such as, for example, a conveyor belt that moves a number of substrates (450) under a reagent deposition area (402) of the reagent dispensing system (400). However, any other type of conveyance system may be used such as, for example, mechanical stages that moves in and out of the reagent deposition area (402), rolls or reels of flexible material that moves underneath the reagent dispensing devices (104) within the reagent modules (103), or other conveyance systems.

The direction of travel of the substrate conveyance system (401) is indicated by arrows (470). As depicted in FIG. 4, a reagent module (103) is located within the reagent deposition area (402) and is considered to be in an in-line position to dispense reagent (105) onto the substrates (450).

In one example, the reagent dispensing system (400) may include a wiping station (403) to wipe off or clean the reagent dispensing devices (104) of the reagent module (103). In one example, the wiping station (403) wipes a nozzle plate or other ejection surface of the at least one reagent dispensing device (104) within the reagent module (103). The reagent dispensing system (400) may also include a capping station (404) to seal a number of nozzles or other ejection devices of the at least one reagent dispensing device (104) from ambient atmosphere around the reagent deposition area (402).

The in-line reagent module (103) in the example of FIG. 4 includes a number of different reagent modules (103-1, 103-2, 103-3, collectively referred to herein as 103) that include differing architectures or form factors that allow them to dispense their respective volumes. For example, the reagent module (103-2) located within the reagent deposition area (402) includes four digitally addressable fluid ejection devices (408-1, 408-2, 408-3, 408-4, collectively referred to herein as 408). In one example, the four digitally addressable fluid ejection devices (408) may each include a volume of reagent (105). The reagent module (103-2) including the digitally addressable fluid ejection devices (408) may dispense an average or mid-range amount of reagent (105), and may be used for dispensing reagents that are dispensed at an average or mid-range frequency.

Other reagent modules (103-1, 103-2, 103-3) may be stored or placed off-line, and may be exchangeable with the in-line reagent module (103-2). Other architectures or form factors of reagent modules (103) may be included within the reagent dispensing system (400). Another architecture or form factor of reagent modules (103) may include a reagent module (103-1) that includes a cassette device (405). As described herein, the cassette device (405) may dispense between approximately 1 picoliter (pL) and 10 microliters (μL) as the first range of volumes of a reagent. The first range of volumes is less than the volumes that may be dispensed using the digitally addressable fluid ejection devices (104-2). The cassette device (405) may include, for example, a T8+ or D4+ dispensing cassette produced and distributed by HP, Inc. With these types of cassettes, a relatively small amount of reagent may be dispensed at a given time using a dispensing die that is capable of dispensing these relatively small volumes of fluid. The cassette device (405) may be used to dispense volumes of fluid that are less frequently dispensed relative to other reagents.

Another architecture or form factor of reagent modules (103) may include a reagent module (103-3) that includes a bulk reagent dispensing device (406). The bulk reagent dispensing device (406) may be fluidically coupled to a bulk reagent source (407) to provide the bulk reagent dispensing device (406) with ample reagent to dispense. The reagent module (103-3) including the bulk reagent dispensing device (406) may dispense a bulk or high-range amount of reagent (105), and may be used for dispensing reagents that are dispensed at above average frequencies.

Thus, the cassette device (405) of the reagent module (103-1) may dispense a first range of volumes. The digitally addressable fluid ejection devices (408) of the reagent module (103-2) may dispense a second range of volumes where the second range of volumes may be more voluminous relative to the first range of volumes. The bulk reagent dispensing device (406) of the reagent module (103-3) may dispense a third range of volumes where the third range of volumes may be more voluminous relative to the second range of volumes. Further, the cassette device (405) of the reagent module (103-1) may be utilized in dispensing reagents that are rarely or less-frequently dispensed. The digitally addressable fluid ejection devices (408) of the reagent module (103-2) may be utilized in dispensing reagents that are dispensed at an average frequency or at least more frequently than those reagents dispensed by the cassette device (405) of the reagent module (103-1). The bulk reagent dispensing device (406) of the reagent module (103-3) may be utilized in dispensing reagents that are very frequently used or at least more frequently used then those reagents dispensed by the digitally addressable fluid ejection devices (408) of the reagent module (103-2).

As depicted in FIG. 4, a number of exchange paths (410) depicted as dashed lines indicate a path on which an off-line reagent module (103) may take when being switched with an in-line module (103). In this example, an automated storage and retrieval system (ASRS) (420) may be used to transport the reagent modules (103) to and from the reagent deposition area (402), The ASRS (420) may include any number of conveyor systems, lift systems, robotic arms, other ASRS systems, and combinations thereof. In another example, a technician may manually exchange the reagent modules (103).

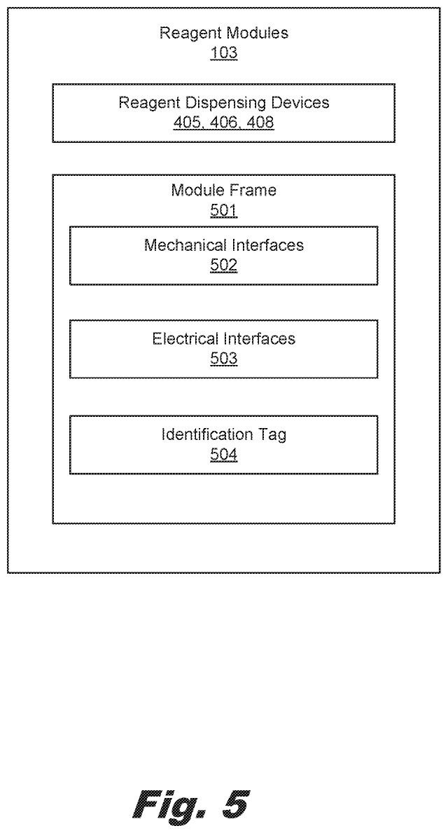

With continued reference to FIG. 4, FIG. 5 is a block diagram of a reagent module (103), according to an example of the principles described herein. When a reagent module (103) is placed in the reagent deposition area (402), a number of mechanical (411) and electrical (412) interfaces within the reagent dispensing system (400) and located at the reagent deposition area (402) interface with mating mechanical (502) and electrical (503) interfaces on the reagent modules (103). In one example, a module frame (501) is included within the reagent module (103). The module frame (501) mechanically and electrically couples the reagent dispensing devices (405, 406, 408) within the reagent module (103) to the reagent dispensing system (100). The module frame (501) may include the mechanical interfaces (502) to align the reagent dispensing devices (104) with respect to the reagent module (103). Further, the module frame may include the electrical interfaces (503) to electrically couple the reagent dispensing devices (104) to the reagent module (103), and, in turn, the reagent dispensing system (100). Signals may be sent by the reagent dispensing system (100) to the reagent dispensing devices (104) via the number of electrical interfaces (503) of the reagent module (103). These signals may be used to instruct the reagent dispensing devices (104) to disperse a volume of reagent (105) onto a substrate (450) located on the dispersion surface (101). In this manner, the reagent modules (103) may be physically coupled to the reagent dispensing system (400) and be seated within the reagent deposition area (402) in order to dispense reagent (105) onto the substrates (450).

Further, in this physically coupled state, a number of electrical interfaces (503) located on the reagent modules (103) electrically interface with the electrical interfaces (412) located in the reagent deposition area (402) of the reagent dispensing system (400). This allows the reagent dispensing system (400) to send instructions in the form of signals to the modules (103) that cause the various reagent dispensing devices (405, 406, 408) to dispense their respective reagents (105) onto the substrates (450).

The reagent modules (103) may each include an identification tag (504). A tag reader (413) may be included within the reagent dispensing system (400) to read the identification tags (504) on the modules. The identification tags (504) communicate with the reagent dispensing system (400), and provide the reagent dispensing system (400) with an identification of the reagents (105) within each of the number of reagent dispensing devices (405, 406, 408) included in the reagent modules (103).

A processing device (414) and a data storage device (415) may be included in the reagent dispensing system (400) to instruct and store data about the reagent modules (103) and their respective reagent dispensing devices (405, 406, 408). The processing device (414) may provide signals to the reagent dispensing devices (405, 406, 408) to instruct the reagent dispensing devices (405, 406, 408) to dispense their respective reagents (105) onto the substrates (450). Further, the processing device (414) may instruct the ASRS (420) to exchange the in-line reagent module (103) with an off-line reagent module (103) in order to dispense a different reagent or volume of reagent. Still further, the processing device (414) may receive data from the tag reader (413) regarding the identification of the reagents (105) within each of the number of reagent dispensing devices (405, 406, 408) included in the reagent modules (103), store that information, and use it in connection with the ASRS (420) and the tag reader (413) to identify and exchange the in-line reagent module (103) with an off-line reagent module (103). The processing device (414) may further provide instructions to the conveyance system (401) as to speed and direction in moving the substrates (450) within the reagent deposition area (402) and under the reagent modules (103).

The data storage device (415) may include various types of memory modules, including volatile and nonvolatile memory. For example, the data storage device (415) of the present example may include Random Access Memory (RAM), Read Only Memory (ROM), and Hard Disk Drive (HDD) memory. Many other types of memory may also be utilized, and the present specification contemplates the use of many varying type(s) of memory in the data storage device (415) as may suit a particular application of the principles described herein. In certain examples, different types of memory in the data storage device (415) may be used for different data storage needs. For example, in certain examples the processor (414) may boot from Read Only Memory (ROM), maintain nonvolatile storage in the Hard Disk Drive (HDD) memory, and execute program code stored in Random Access Memory (RAM). The data storage device (415) may comprise a computer readable medium, a computer readable storage medium, or a non-transitory computer readable medium, among others. For example, the data storage device (415) may be, but not limited to, an electronic, magnetic, optical, electromagnetic, infrared, or semiconductor system, apparatus, or device, or any suitable combination of the foregoing. More specific examples of the computer readable storage medium may include, for example, the following: an electrical connection having a number of wires, a portable computer diskette, a hard disk, a random-access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that can contain, or store computer usable program code for use by or in connection with an instruction execution system, apparatus, or device. In another example, a computer readable storage medium may be any non-transitory medium that can contain, or store a program for use by or in connection with an instruction execution system, apparatus, or device.

The reagent dispensing system (400) may further include at least one environmentally-controlled area (430) to preserve a number of reagents (105) within the reagent modules (103). Many reagents dispensable by the reagent modules (103) may have a shelf life or may perform better in a reaction if they are stored in an area where its environment may be controlled. The environmentally-controlled areas (430) may be environmentally sealed from the remainder of the reagent dispensing system (400), and may control, for example, a humidity level, a temperature, a pressure, or other environmental states within the reagent dispensing system (400).

Further, in one example, the environmentally-controlled area (430) may be located at the reagent deposition area (402) such that a reagent module (103) located at an in-line position ready for dispensing may be environmentally controlled during a reagent dispensing operation. This may preserve the reagents within the reagent modules even during dispensing of the reagents.

Although only one reagent deposition area (402) is depicted in the reagent dispensing system (400) as a station at which the reagent modules (103) may dispense their respective reagents, the reagent dispensing system (400) may include a plurality of stations located along the substrate conveyance system (401). Each of the plurality of stations including a reagent deposition area (402) located along the substrate conveyance system (401) may include the mechanical (411) and electrical (412) interfaces to interface with the reagent modules (103).

Aspects of the present systems and methods are described herein with reference to flowchart illustrations and/or block diagrams of methods, apparatus (systems) and computer program products according to examples of the principles described herein. Each block of the flowchart illustrations and block diagrams, and combinations of blocks in the flowchart illustrations and block diagrams, may be implemented by computer usable program code. The computer usable program code may be provided to the processing device (414), such that the computer usable program code, when executed via, for example, the processing device (414) of the reagent dispensing system (100, 400) or other programmable data processing apparatus, implement the functions or acts specified in the flowchart and/or block diagram block or blocks. In one example, the computer usable program code may be embodied within a computer readable storage medium; the computer readable storage medium being part of the computer program product. In one example, the computer readable storage medium is a non-transitory computer readable medium.

The specification and figures describe a reagent dispensing system. The reagent dispensing system includes at least one station located in-line with respect to a dispersion surface, and a reagent module located at the at least one station. The reagent module may include a first reagent dispensing device to dispense a first range of volumes of a first reagent, and a second reagent dispensing device to dispense a second range of volumes of a second reagent where the second range of volumes being more voluminous relative to the first range of volumes. The reagent dispensing system may further include a third reagent dispensing device to dispense a third range of volumes of a third reagent where the third range of volumes being more voluminous relative to the second range of volumes.

The reagent dispensing system provides for multiple reagent dispensing device types that provide efficient management and use of fluids that vary widely in terms of their optimal dispensing environmental conditions and their usage rate. Dispensing reagents using the reagent dispensing devices described herein is more effective over other, pipette-based methods, because of the level of control and ease-of-use enabled with the reagent dispensing system. Further, the reagent dispensing devices provide for dispensed reagents to be placed with digitally addressed precision where desired onto a substrate, including, for example, onto specific regions of a tissue sample. Digitally addressed fluid ejection of reagents provides for up to one thousand times improved efficiency in reagent dispensing and reduction in waste as regarding the reagents. Further, digitally addressed fluid ejection of reagents can be easily combined on a substrate in a digital fashion with, for example, multiple reagents being positioned next to each other or on the same location, as desired in order to bring about a reaction or provide a true mixture of reagents on the substrate.

The preceding description has been presented to illustrate and describe examples of the principles described. This description is not intended to be exhaustive or to limit these principles to any precise form disclosed. Many modifications and variations are possible in light of the above teaching.

What is claimed is:

1. A reagent dispensing system comprising:
at least one station located in-line with respect to a dispersion surface;
a reagent module located at the at least one station comprising:
a first reagent dispensing device to dispense a first range of volumes of a first reagent; and
a second reagent dispensing device to dispense a second range of volumes of a second reagent, the second range of volumes being more voluminous relative to the first range of volumes.

2. The reagent dispensing system of claim 1, comprising a third reagent dispensing device to dispense a third range of volumes of a third reagent, the third range of volumes being more voluminous relative to the second range of volumes.

3. The reagent dispensing system of claim 2, wherein the third reagent dispensing device is fluidically coupled to an off-line bulk supply of reagent.

4. The reagent dispensing system of claim 1, wherein the reagent module comprises:
a number of mechanical interfaces to align the reagent module with respect to the reagent dispensing system; and
a number of electrical interconnects to electrically interface the reagent module to the reagent dispensing system, the reagent dispensing system to send dispensing signals through the electrical interconnects to the reagent dispensing devices.

5. The reagent dispensing system of claim 1, wherein the reagent module comprises a number of mechanical interfaces to align the reagent dispensing devices with respect to the reagent module.

6. The reagent dispensing system of claim 1, an identification located on each of the reagent modules, the identification identifying a number of reagents within each of the reagent dispensing devices.

7. The reagent dispensing system of claim 1, wherein:
the first reagent dispensing device comprises a cassette, the cassette comprising a number of first dispensing die to dispense the first range of volumes of a reagent; and
the second reagent dispensing device comprises a digitally addressable fluid ejection device, the digitally addressable fluid ejection device comprising a number of second dispensing die to dispense the second range of volumes of the second reagent.

8. The reagent dispensing system of claim 1, comprising at least one environmentally-controlled area within the reagent dispensing system to preserve a number of reagents within the reagent modules.

9. The reagent dispensing system of claim 1, wherein the at least one station comprises a plurality of stations located along a reagent dispersion area, comprising:
a number of mechanical interfaces to align the reagent modules with respect to the reagent dispensing system at each station; and
a number of electrical interconnects to electrically interface the reagent modules to the reagent dispensing system, the reagent dispensing system to send dispensing signals through the electrical interconnects to the reagent dispensing devices at each station.

10. A reagent module comprising:
a plurality of reagent dispensing devices; and
a module frame coupling the reagent dispensing devices to a reagent dispensing system, the module frame comprising:
a number of electrical interconnects to electrically interface the reagent dispensing devices to the reagent dispensing system, the reagent dispensing system to send dispensing signals through the electrical interconnects to the reagent dispensing devices, wherein the reagent dispensing devices comprise:
a first reagent dispensing device to dispense a first range of volumes of a reagent;
a second reagent dispensing device to dispense a second range of volumes of the reagent, the second range of volumes being more voluminous relative to the first range of volumes; and
a third reagent dispensing device to dispense a third range of volumes of the reagent, the third range of volumes being more voluminous relative to the second range of volumes.

11. The reagent module of 10, wherein the reagent dispensing devices comprise a number of mechanical interfaces to align the reagent dispensing device with respect to the reagent dispensing system.

12. The reagent module of 10, wherein
the first reagent module is a cassette; and
the second reagent module comprises a fluid ejection device comprising a number of nozzles through which the second reagent is jetted; and
the third reagent module comprises a bulk fluid dispensing device.

13. A computer program product for dispensing a reagent, the computer program product comprising:
a non-transitory computer readable medium comprising computer usable program code embodied therewith, the computer usable program code to, when executed by a processor:
identify a plurality of reagent modules, the reagent modules comprising:
a first reagent module to dispense a first range of volumes of a first reagent;
a second reagent module to dispense a second range of volumes of a second reagent, the second range of volumes being more voluminous relative to the first range of volumes; and
a third reagent module to dispense a third range of volumes of a third reagent, the third range of volumes being more voluminous relative to the second range of volumes; and
dispense the first, second, and third reagents based on a number of test protocols.

14. The computer program product of claim 13, wherein identifying a plurality of reagent modules comprises, with an identification module, identifying first, second, and third reagents within each of the reagent modules based on an identification associated with the reagent modules.

15. The computer program product of claim 13, comprising computer usable program code to, when executed by the processor, exchange the reagent modules based on a type of the test protocol conducted,
wherein exchanging the reagent modules comprises instructing a reagent module transport system to exchange one of the first, second, and third reagent modules positioned at a reagent dispensing area for another of the first, second, and third reagent modules.
